(19) United States
(12) Patent Application Publication
(10) Pub. No.: US 2023/0142645 A1
(43) Pub. Date: May 11, 2023

(54) Microsphere-Coated Polyurethane Articles and Methods of Making the Same

(71) Applicant: 3M INNOVATIVE PROPERTIES COMPANY, St. Paul, MN (US)

(72) Inventors: Yongshang Lu, Woodbury, MN (US); Charlie C. Ho, Woodbury, MN (US); Ryan M. Braun, St. Paul, MN (US); John J. Jaros, Lake Elmo, MN (US); Shri Niwas, Maple Grove, MN (US); Ying Xia, Woodbury, MN (US)

(21) Appl. No.: 17/912,200

(22) PCT Filed: Apr. 9, 2021
(86) PCT No.: PCT/IB2021/052958

§ 371 Date: Sep. 16, 2022

Related U.S. Application Data
(60) Provisional application No. 63/011,498, filed on Apr. 17, 2020.

(51) Int. Cl. B32B 27/08; B32B 27/40; B32B 7/12; B32B 27/36; B32B 27/20; C08G 18/12; C08G 18/32; C08G 18/42; C08K 3/40; C08K 9/04; C09J 7/38; C08J 7/046

(52) U.S. Cl. CPC B32B 27/08; B32B 7/12; B32B 27/20; B32B 27/36; B32B 27/40; C08G 18/12; C08G 18/3206; C08G 18/4202; C08G 18/4213; C08G 18/4238; C08G 18/4269; C08J 7/046; C08K 3/40; C08K 9/04; C09J 7/385; B32B 2250/03; B32B 2307/418; B32B 2307/732; B32B 2315/08; B32B 2367/00; B32B 2375/00; C09J 2433/00; C09J 2467/005; C09J 2475/006

(57) ABSTRACT

Described herein is a multilayered article and methods of making and using such articles. The multilayered article comprises: · (a) a microsphere layer comprising a plurality of microspheres (11) disposed in a monolayer; · (b) a bead bonding layer (12) comprising a first major surface and a second opposing major surface wherein the plurality of microspheres is at least partially embedded in the first major surface of the bead bonding layer, and wherein the bead bonding layer comprises a thermoset polyurethane, and wherein the thermoset polyurethane is derived from one or more liquid polyols; and · (c) an elastomeric layer (14) disposed on the second opposing major surface of the bead bonding layer.

### TECHNICAL FIELD

A multilayered article comprising microspheres embedded in a polyurethane layer, which is disposed on an elastomeric layer is discussed along with methods of making such articles. The articles of the present disclosure can be useful, for example, in applications, which require mechanical durability and weatherability, such as in paint protection or paint replacement applications for automotive, watercraft, and aerospace industries.

### DESCRIPTION OF THE FIGURES

Embodiments of the present disclosure are illustrated by way of example, in the accompanying drawings, which are for illustrative purposes only and not drawn to scale.

FIG. 1 is a schematic cross-sectional view of a microsphere-coated polyurethane article according to one embodiment of the present disclosure;

FIG. 2 is a schematic cross-sectional view of a microsphere-coated polyurethane article according to one embodiment of the present disclosure; and

FIGS. 3A-3D depicts a method of making an article according to one embodiment of the present disclosure.

### SUMMARY

There is a desire to identify microsphere coated articles having good durability (such as abrasion resistance, and chip resistance) as well as weatherability. There is a desire to find processes to make these multilayered articles, which are more efficient and or less expensive. Such multilayered articles can find application as surface coverings in the paint protection or paint replacement applications for automotive, watercraft, and aerospace industries.

In one aspect, an article is provided. The article (also referred to herein as a multilayered article) comprising:
(a) a microsphere layer comprising a plurality of microspheres;
(b) a bead bonding layer comprising a first major surface and a second opposing major surface wherein the plurality of microspheres is at least partially embedded in the first major surface of the bead bonding layer, and wherein the bead bonding layer comprises a thermoset polyurethane, and wherein the thermoset polyurethane is derived from one or more liquid polyols; and
(c) an elastomeric layer disposed on the second opposing major surface of the bead bonding layer.

In another aspect, a method of making a multilayered article, the method comprising:
providing an elastomeric layer;
disposing onto a first major surface of the elastomeric layer a solventless curable polyurethane coating layer and a plurality of microspheres to form a curable multilayered article; and then curing the curable multilayered article.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B);
“ambient conditions” means at a temperature of 25° C. and a pressure of 1 atmosphere (approximately 100 kilopascals);
“ambient temperature” means at a temperature of 25° C.;
“catalyst” means a substance that can increase the speed of a chemical reaction;
“diol” means a compound having a hydroxyl functionality of exactly two;
“diisocyanate” means a compound having an isocyanate functionality of exactly two;
“cure” means to alter the physical state and or chemical state of the composition to make it transform from a fluid to less fluid state, to go from a tacky to a non-tacky state, to go from a soluble to insoluble state, to decrease the amount of polymerizable material by its consumption in a chemical reaction, or go from a material with a specific molecular weight to a higher molecular weight;
“curable” means capable of being cured;
“essentially free of” means having only trace amounts of a given substance, for example having less than 0.5%, 0.4, 0.3, 0.2, 0.1, 0.05, 0.02, 0.01, 0.005, or 0.001% by weight of that substance;
“fully cured” means cured to a state where the composition is suitable for use in its intended application;
“partially cured” means cured to a state that is less than fully cured;
“polyisocyanate” means a compound having an isocyanate functionality of two or more; and
“polyol” means a compound having a hydroxyl functionality of two or more.

The term “substituted” as used herein in conjunction with a molecule in which one or more hydrogen atoms contained therein are replaced by one or more non-hydrogen atoms. Examples of substituents or functional groups that can be substituted include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(=NH)N(R)₂, C(O)N(OR)R, and C(=NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

The present disclosure is directed toward a microsphere-containing multilayered article, which has, among other things, good mechanical durability (e.g., abrasion resistance, chip resistance, and/or pencil hardness), and weather durability (such as heat, and/or UV-resistance). These multilayered articles can be applied to surfaces to alter the properties of the surface.

The multilayered articles of the present disclosure comprise a microsphere layer comprising a plurality of microsphere. The plurality of microspheres is at least partially embedded in the first major surface of a bead bonding layer, and the bead bonding layer is disposed on an elastomeric layer.

### Elastomeric Layer

The elastomeric layer can be an elastomer or a thermoplastic elastomer. The elastomeric layer should have elastomeric properties, enabling the layer to absorb impacts from small objects, such as rocks, while also allowing flexibility of the multilayered article.

The elastomeric layer may include polyurethane; polyvinyl chloride; olefinic polymers; epichlorohydrin rubber; acrylate-based rubbers such as polyacrylic rubber (ACM) and acrylate-butadiene rubber (ABR); silicone rubbers such as vinyl-methyl-silicone (VMQ); fluorine-containing elastomers; polyether block amides available under the trade designation PEBAX by Arkema Inc., King of Prussia, PA or VESTAMID E from Evonik Industries AG, Marl, Germany; chlorosulfonated polyethylene for example, available under the trade designation HYPALON from DuPont Performance Elastomers, Wilmington, DE; and ethylene-vinyl acetate.

Exemplary olefinic polymers include polypropylene, polyethylene, or copolymers of polyethylene including a polyethylene-acrylic acid copolymer such those available under the trade designation PRIMACOR by Dow Chemical, Midland, MI; polyethylene-methylacrylic acid copolymer such those available under the trade designation SURLYN by DuPont Packaging & Industrial Polymers, Wilmington, DE; a copolymer of ethylene and propylene (EPM); and a copolymer of ethylene, propylene and a diene-component (EPDM).

Exemplary fluorine-containing elastomers include a fluorosilicone rubber such as fluorovinylmethylsiloxane rubber (FVMQ); and partially and fully fluorinated elastomers such as those derived from tetrafluoroethylene, hexafluoropropylene, vinylidene fluoride, chlorotrifluoroethylene, partially and fully fluorinated vinyl ethers, and partially and fully fluorinated allyl ethers. Exemplary fluorinated elastomers include copolymers of tetrafluoroethylene and propylene; copolymers of hexafluoropropylene and vinylidene fluoride; copolymers of tetrafluoroethylene, hexafluoropropylene, vinylidene fluoride, and perfluorinated vinyl ethers (such as perfluorinated methyl vinyl ether); and copolymers of tetrafluoroethylene and perfluorinated vinyl ethers. Commercially available fluorinated elastomers include those available under the trade designations VITON from The Chemours Company, Wilmington, DE; TECNOFLON from Solvay Specialty Polymers USA, LLC., Alpharetta, GA; 3M DYNEON FLUOREL from 3M Co., Maplewood, MN; AFLAS from AGC Chemicals Europe, Ltd., Thomton-Cleveleys, UK; DAI-EL from Daikin America, Inc., Orangeburg, NY; KALREZ from DuPont de Nemours, Inc. Wilmington, DE; CHEMRAZ from Greene, Tweed NC, LLC, Charlotte, NC; and PERLAST from Precision Polymer Engineering, Santa Clara, CA.

Generally, the elastomeric layer should be selected to have compatibility with the bead bonding layer to enable good interlayer adhesion without the use of intermediary layers (e.g., tie layers) to improve adhesion therebetween.

In one embodiment, the elastomeric layer has a glass transition temperature of less than 50, 40, 30, 25, 20, 15, 10, 5, 0, -5, -10, -15, or even -20° C. The glass transition temperature may be determined using techniques known in the art, for example, using dynamic mechanical analyzer such as DMA Q800 from TA Instruments, New Castle, DE with a ramp rate of 10° C./min at 1 Hz.

The thickness of the elastomeric layer is not particularly restricted. Preferably, the elastomeric layer is sufficiently thin to allow the overall multilayered article to stretch as needed to conform to a substrate having three-dimensional contours that are curved or irregularly shaped, and yet sufficiently thick to protect the substrate against scratches and impacts encountered in use. The thickness of the elastomeric layer can be at least 50, 60, 70, 80, 100, or even 150 micrometers. The thickness of the elastomeric layer can be at most 100, 150, 200, 250, 300, 250, 300, 350, 400, 450, 500, 550, or even 600 micrometers.

In one embodiment, the polyurethane has an elongation at break of at least 200, 400, 600, or even 800% when tested, for example, by ASTM D-882-18 will a pull rate of 12 in/min (30 cm/min) with a jaw gap of 1 in (30 cm) using, for example, an Instron model 5565 (Norwood, MA).

In one embodiment, the elastomeric layer comprises a polyurethane, such as a thermoplastic elastomer.

The polyurethane in the elastomeric layer can have a weight-average molecular weight in a range of from at least about 80,000; 85,000; 90,000; 100,000; 150,000; or even 175,000 daltons; and at most 200,000; 300,000, or even 400,000 daltons. In some embodiments, the weight-average molecular weight is more than 400,000 daltons.

In one embodiment, the polyurethane of the elastomeric layer is a reaction product of a reaction mixture that includes a diisocyanate, a polymeric diol, and a chain extender.

The diisocyanate refers to a molecule having two isocyanate (—N═C═O) functional groups. An example of a suitable diisocyanate includes a diisocyanate according to Formula I:

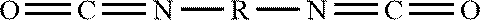

Wherein R is a C₁- C₄₀)alkylene, (C₂- C₄₀)alkenylene, (C₄-C₂₀)arylene, (C₄-C₂₀)arylene-(C₁-C₄₀)alkylene-(C₄-C₂₀)arylene, (C₄-C₂₀)cycloalkylene, or (C₄-C₂₀)aralkylene, which may be substituted or unsubstituted. Exemplary diisocyanates include: dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluylene diisocyanate, diphenylmethane 4,4′-diisocyanate, 1,4-diisocyanatobutane, 1,8-diisocyanatooctane, 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate, methylenediphenylene-4,4′-diisocyanate, (4,4′-diisocyanato-3,3′,5,5′-tetraethyl) diphenylmethane, 4,4′-diisocyanato-3,3′-dimethoxybiphenyl (o-dianisidine diisocyanate), 5-chloro-2,4-toluene diisocyanate, 1-chloromethyl-2,4-diisocyanato benzene, tetramethyl-m-xylylene diisocyanate, 1,6-diisocyanatohexane 1,12-diisocyanatododecane, 2-methyl-1,5-diisocyanatopentane, methylenedicyclohexylene-4,4′-diisocyanate, 3-isocyanatomethyl-3,5,5-trimethylcyclohexyl isocyanate, 2,2,4-trimethylhexyl diisocyanate, or a mixture thereof.

The amount of diisocyanate used to form the elastomeric layer can range from at least 0.5, 1, 1.5, 2, 3, 5, 8, or even 10 wt (weight)%; and at most 15, 20, 25, 30, 35, 40, 45, or even 47 wt% of the reaction mixture. The amount of the diisocyanate in the reaction mixture of the elastomeric layer can be expressed in terms of an isocyanate index. An isocyanate index can be generally understood to refer to the ratio of the equivalent amount of isocyanate functional groups used relative to the theoretical equivalent amount of hydroxyl functional groups. The theoretical equivalent amount is equal to one equivalent isocyanate functional group per one equivalent hydroxyl group; this is an index of 1.00. In one embodiment, the isocyanate index of the reaction mixture used to form the elastomeric layer is at least 0.99, 1.00, 1.02, 1.03, 1.04, or even 1.05; and at most 1.10, 1.12, 1.14, 1.16, 1.18, or even 1.20.

The term polymeric diol used herein includes both polymers and small molecules having two hydroxyl (-OH) groups. Diols can be selected from the group consisting of: caprolactone diols, polycarbonate diols, polyester diols, acrylic diols, polyether diols, polyolefin diols, and mixtures thereof.

The amount of polymeric diol used to form the elastomeric layer can range from at least 43, 45, or even 50 wt%; and at most 55, 60, 65, or even 70 wt% of the reaction mixture.

In one embodiment, the polymeric diol is a polyester diol. In one embodiment, the polyester diol can be a reaction product of a condensation reaction such as a polycondensation reaction. However, the polyester polyol is not made via a ring opening polymerization reaction.

In examples where the polyester diol is made according to a condensation reaction, the reaction can be between one or more carboxylic acids and one or more polymeric diols. An example of a suitable carboxylic acid includes a carboxylic acid according to Formula II, having the structure:

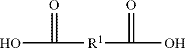

Wherein R¹ is a (C₁- C₄₀)alkylene, (C₂- C₄₀)alkylene, (C₂- C₄₀)alkenylene, (C₄-C₂₀)arylene, (C₄-C₂₀)cycloalkylene, or (C₄-C₂₀) aralkylene, which may be substituted or unsubstituted. Specific examples of suitable carboxylic acids include glycolic acid (2-hydroxyethanoic acid), lactic acid (2-hydroxypropanoic acid), succinic acid (butanedioic acid), 3-hydoxybutanoic acid, 3-hydroxypentanoic acid, terepthalic acid (benzene-1,4-dicarboxylic acid), naphthalene dicarboxylic acid, 4-hydroxybenzoic acid, 6-hydroxynaphtalane-2-carboxylic acid, oxalic acid, malonic acid (propanedioic acid), adipic acid (hexanedioic acid), pimelic acid (heptanedioic acid), ethanoic acid, suberic acid (octanedioic acid), azelaic acid (nonanedioic acid), sebacic acid (decanedioic acid), glutaric acid (pentanedioic acid), dedecandioic acid, brassylic acid, thapsic acid, maleic acid ((2Z)-but-2-enedioic acid), fumaric acid ((2E)-but-2-enedioic acid), glutaconic acid (pent-2-enedioic acid), 2-decenedioic acid, traumatic acid ((2E)-dodec-2-enedioic acid), muconic acid ((2E,4E)-hexa-2,4-dienedioic acid), glutinic acid, citraconic acid((2Z)-2-methylbut-2-enedioic acid), mesaconic acid ((2E)-2-methyl-2-butenedioic acid), itaconic acid (2-methylidenebutanedioic acid), malic acid (2-hydroxybutanedioic acid), aspartic acid (2-aminobutanedioic acid), glutamic acid (2-aminopentanedioic acid), tartonic acid, tartaric acid (2,3-dihydroxybutanedioic acid), diaminopimelic acid ((2R,6S)-2,6-diaminoheptanedioic acid), saccharic acid ((2S,3S,4S,5R)-2,3,4,5-tetrahydroxyhexanedioic acid), mexooxalic acid, oxaloacetic acid (oxobutanedioic acid), acetonedicarboxylic acid (3-oxopentanedioic acid), arbinaric acid, phthalic acid (benzene-1,2-dicarboxylic acid), isophtalic acid, diphenic acid, 2,6-naphtalenedicarboxylic acid, or a mixture thereof.

An example of a suitable diol includes a diol according to Formula III, having the structure:

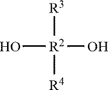

wherein R² is a (C₁- C₄₀)alkylene, (C₂- C₄₀)alkenylene, (C₄-C₂₀)arylene, (C₁- C₄₀)acylene, (C₄-C₂₀)cycloalkylene, (C₄-C₂₀)aralkylene, or (C₁- C₄₀)alkoxyene, which may be substituted or unsubstituted; and R³ and R⁴ are independently chosen from —H, —OH, (C₁- C₄₀)alkyl, (C₂-C₄₀)alkenyl, (C₄-C₂₀)aryl, (C₁-C₂₀)acyl, (C₄-C₂₀)cycloalkyl, (C₄-C₂₀)aralkyl, and (C₁- C₄₀)alkoxy, which may be substituted or unsubstituted.

An example of another suitable polyol includes a compound according to Formula IV, having the structure:

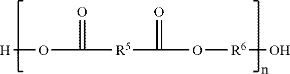

wherein R⁵ and R⁶ are independently chosen from (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, or (C₁-C₄₀)alkoxyene, which may be substituted or unsubstituted; and n is a positive integer greater than or equal to 1 (for example, greater than 2, 4, 5, or even 10).

An example of another suitable polyol includes a compound according to Formula V, having the structure:

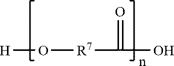

Wherein R⁷ is a (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, or (C₁-C₄₀)alkoxyene, which may be substituted or unsubstituted; and n is a positive integer greater than or equal to 1(for example, greater than 2, 4, 5, or even 10). In specific examples, the polyester polyol includes one or more of polyglycolic acid (poly[oxy(1-oxo-1,2-ethanediyl)]), polybutylene succinate (poly(tetramethylene succinate)), poly(3-hydroxybutyrate-co-3-hydroxyvalerate), polyethylene terephthalate (poly(ethyl benzene-1,4-dicarboxylate)), polybutylene terephthalate (poly(oxy-1,4-butanediyloxycarbonyl-1,4-phenylenecarbonyl)), polytrimethylene terephthalate (poly(trimethylene terephthalate); poly(oxy-1,3-propanediyloxycarbonyl-1,4-phenylenecarbonyl)), polyethylene naphthalate (poly(ethylene 2,6-naphthalate)), poly(1,4-butylene adipate), poly(1,6-hexamethylene adipate), poly(ethylene-adipate), mixtures thereof, and copolymers thereof. However, the polyester polyol is free of polycaprolactone polyol ((1,7)-polyoxepan-2-one).

An appropriate melting temperature can help to increase the degree of crystallinity of the elastomeric layer. The degree of crystallinity can be determined through differential scanning calorimetry and is expressed as the fractional amount of crystallinity in the polyurethane thermoplastic elastomer. The degree of crystallinity can be in a range of from at least 30, 40, or even 50% to at most 55, 60, 65, or even 70%. The degree of crystallinity can make it easier to roll the elastomeric layer as it takes a relatively high temperature to begin to liquefy the elastomeric layer.

A chain extender can be added to the reaction mixture used to form the elastomeric layer to increase the molecular weight of the resulting polyurethane and strengthen the elastomeric layer. The chain extender can be in a range of from at least 1, 1.5, 2, 2.5, 3, 4, or even 5 wt%; and at most 6, 7, 8, 10, 11, or even 13 wt% of the reaction mixture.

In one embodiment, the chain extender is a diol chain extender having two hydroxyl groups. The diol chain extender has weight-average molecular weight of at least 30, 40, 50, 60 or even 80 daltons; and at most 100, 125, 150, 175, 200, 225, or even 250 daltons. The diol chain extender can include any suitable number of carbons. For example, the diol chain extender can include a number-average number of about 2 carbons to about 20 carbons, about 3 carbons to about 10 carbons, or less than, equal to, or greater than about 2 carbons, 3, 4, 5, 6, 7, 8, 9, 10, 11, 12, 13, 14, 15, 16, 17, 18, 19, or 20 carbons. Diol chain extenders comprising relatively short chains can be stiffer than a longer chain diol, resulting in strengthen the elastomeric layer. The short chain diols can be stiffer, for example, because the short chain diol is more restricted in terms of rotation about the individual bonds along the chain. Examples of suitable diol chain extenders include ethylene glycol, diethylene glycol, triethylene glycol, tetraethylene glycol, propylene glycol, dipropylene glycol, tripropylne glycol, 1,3-propanediol, 1,3-butanediol, 1,4-butanediol, neopentyl glycol, 1,6-hexanediol, 1,4-cyclohexanedimethanol, or a mixture thereof.

In one embodiment, the polyurethane thermoplastic elastomer includes a hard segment. A hard segment generally refers to harder, less flexible polymer segment, which results from polymerization of the diisocyanate and the diol chain extender. The amount of the hard segment can be determined by calculating the total amount (wt%) of isocyanate, chain extender, and crosslinker. That total amount is then divided by the total weight of the polyurethane thermoplastic elastomer. The hard segment can be in a range of from at least 30, 32, 34, 36, 38, or even 40 wt% to at most 45, 48, 50, 53, or even 55 wt% of the polyurethane thermoplastic elastomer. Hard segments are present as domains, which can interact with each other to effectively form a crosslink therebetween (e.g., through a hydrogen bond). Under stress for example, through a mechanical deformation, the hard segments can become aligned in the stress direction. This alignment coupled with the hydrogen bonding can contribute to the stiffness, elastomeric resilience, or tear resistance of the elastomeric layer.

In some examples, the reaction mixture used to form the elastomeric layer can include a crosslinker. Examples of crosslinkers include polyhydroxy group compounds and polyisocyanate compound. For example, the polyhydroxy compounds can include 3 hydroxy groups or 4 hydroxy groups. The polyisocyanate can include 3 cyano groups or 4 cyano groups. While there are many suitable crosslinkers, the reaction mixture is free of an aziridine crosslinker. If present, the crosslinkers can function to crosslink the polyurethane chains of the elastomeric layer.

### Bead Bonding Layer

The bead bonding layer of the present disclosure is a thermoset polyurethane (wherein a thermoset is a polymer which does not have a bulk softening temperature and cannot be melted or shaped after polymerization/cure). The bead bonding layer of the present disclosure is derived from a reactive composition substantially free of solvent. As used herein, substantially free of solvent means that the composition of reactive materials used to make the bead bonding layer contains an amount of water or organic solvents less than 3, 2, 1, 0.5, 0.1, even 0.05 wt% or even no detectable organic solvents or water based on the total weight on the composition. Organic solvents include chemicals (such as methyl ethyl ketone, acetone, xylene, etc.), which are used to dissolve the reactive components to make the bead bonding layer, and do not polymerize or cure to form the bead bonding layer. Water and/or organic solvents can negatively impact the finished article because for example, water can react with isocyanates causing outgassing of the polyurethane. Similarly, organic solvent can also cause outgassing. Outgassing can lead to bubble defects and/or compromise the adhesion between the bead bonding layer and adjacent layers such as the elastomeric layer or the microspheres.

In one embodiment, the bead bonding layer has primary aliphatic isocyanate crosslinking and is a reaction product of two reaction components. The first reaction component includes one or more polyols. The polyol portion of the first component has an equivalent weight (e.g., molecular weight divided by the number of alcohol groups) in the range from at least about 28, 30, 50, 75, 100, 150, or even 200; and at most about 250, 300, 350, 400, 500, 600, 800, 1000, 1500, 2000, 2500, or even 3000. The first component also includes one or more diols having an equivalent weight in the range from about at least 30, 50, 75, 100, 150, 200, 250, 300, 350, 400, or even 450; and at most about 500, 550, 600, 650, 700, 800, 1000, 1500, 2000, 2500, 3000, 3500, or even 4000. The desired diol is a combination of a short chain diol, having an equivalent weight in the range from about 30 to about 400, and a polymeric diol, having an equivalent weight in the range from about 400 to about 4000. Polyol and diol compounds suitable for use in the first component may include polyesters, polycarbonates, polyacrylates, polyalkylenes, and polyethers, or combinations thereof. Additionally, a catalyst is included in the first component.

The second component includes a primary aliphatic polyisocyanate crosslinker. The noted polyisocyanate preferably represents at least about 50 weight percent of the total isocyanate present in the second component. The first and second components are combined to form a solvent-free admixture which may then be applied onto a desired substrate and cured. The viscosity of the admixture is generally in the range of about 400 cps to about 5000 cps at 25° C.

The preferred polyurethane of the present disclosure has primary aliphatic isocyanate crosslinking. The polyurethane is the reaction product of a two component system. The resulting reaction mass of the two components is generally solvent-free.

The first reaction component contains one or more polyols, optionally, one or more diols, and a catalyst. At least one of the polyols used is a liquid, meaning that at ambient pressure (such as 1 atm), and a temperature of at least 25, 30, 45, 50, or even 60° C., the polyol has a viscosity, as measured by a Brookfield Viscometer of at most 6000, 5000, 3000, 2000, or even 1000 cP through a parallel plate rheometer. In one embodiment, the polyol is a compound having 3 or more hydroxyl groups. The polyols are generally selected from the group consisting of polyesters, polycarbonates, polyacrylates, polyalkylenes, and polyethers, or combinations thereof. The polyol, or combined polyols, have an equivalent weight in the range of about 28 to about 3000. In the present disclosure, equivalent weight corresponds to the molecular weight of the material divided by the number of hydroxyl groups. In one embodiment, a combinations of polyols within the noted equivalent weight limitation may be used. However, the amount of polyether in the first reaction component, whether provided as a polyol or diol, preferably should not exceed about 40 weight percent of the first component. Amounts of polyethers in excess of the noted limitation can adversely affect the clarity or the weathering properties of the present disclosure. Desirably, polyester based polyols and diols, forming greater than about 20 weight percent polyester in the first reaction component, are used in the present disclosure in order to improve outdoor durability. The polyol comprises in the range from greater than about 10 weight percent of the first reaction component.

Optionally, one or more diols are included in the first reaction component. The diols are compounds that have two hydroxyl groups. In addition to polyester diols, polycarbonate, polyacrylate, polyalkylene, and polyether diols, or combinations of the noted compounds, may be used. The one or more diols have a combined equivalent weight in the range of about 30 to about 4000. Additionally, the diols comprise in the range up to about 65 weight percent of the first reaction component. Desirably, the diols include the combination of a short chain diol, having an equivalent weight in the range from about 30 to about 400, and a polymeric, or long chain diol having an equivalent weight in the range of from about 400 to about 4000. Additionally, it has been found that when a polyester and a polyether are used in the first reaction component, the combined amount of polyether, whether provided as a polyol or diol, preferably should not exceed about 40 weight percent of the first reaction component.

Exemplary liquid polyols include the following. MPD adipate-based polyols available under the trade designation Kuraray Polyol P-510, P-1010, P-2010, P-3010, P-4010, P-5010 and P-6010 from Kuraray America Inc., Houston, TX. MPD/TMP adipate-based polyols available under the trade designation Kuraray Polyol F-510, F-1010, F-2010, and F-3010 from Kuraray America Inc. MPD adipate-based polyols available under the trade designation Kuraray Polyol P-201 1, and P-2013. P-1012, P-2012, P-530, P-2030, and P-2050 from Kuraray America Inc. Carbonate polyols available under the trade designation Kuraray Polyol C-590, C-1050, C-1090, C-2050, C-2090, and C-3090 from Kuraray America Inc. Polyester polyols available under the trade designation FOMREZ Polyester polyols 11-45, 11-56, 11-112, and 11-225 from Chemtura Corp., Middlebury, CT and CAPA 2043, 2047A, 2054, 8025D, 3031, 3050, 3091, 8025E and 4101 from Ingevity Corp., North Charleston, SC.

The first reaction component of the present disclosure preferably comprises a catalyst. The isocyanate groups of the second component react with the hydroxyl groups of the first component under the influence of the catalyst to form urethane linkages. Conventional catalysts generally recognized for use in the polymerization of urethanes may be suitable for use with the present disclosure. For example, aluminum, bismuth, tin, vanadium, zinc, or zirconium-based catalysts may be used with the present disclosure. Though not desired because of their potential toxicity, mercury-based catalyst may also be used. The desired catalysts are tin based catalyst. Tin based catalyst have been found to significantly reduce the amount of outgassing present in the polyurethane. Most desirable are dibutyl tin compounds. Even more desirable are the catalyst selected from the group consisting of dibutyltin diacetate, dibutyltin dilaurate, dibutyltin diacetylacetonate, dibutyltin dimercaptide, dibutyltin dioctoate, dibutyltin dimaleate, dibutyltin acetonylacetonate, and dibutyltin oxide. The catalyst is preferably included at levels of at least 200 ppm in the first component and more preferably at 300 ppm or greater.

Optionally, the first reaction component of the present disclosure can include various additives. For example, leveling agents may be utilized in the first reaction component to ensure a smooth finish to the exposed surface of the polyurethane. A polyethylene oxide modified polymethyl siloxane can be utilized in the present disclosure as a leveling agent. However, other leveling agents generally recognized by one of ordinary skill in the art may also be suitable for use with the disclosure. The leveling agents are desirably included in the range from about 0.01 weight percent to about 1 weight percent.

Another additive to the first component can include UV absorbers which improve the weather resistance of the thermoset polyurethane. The UV absorbers generally recognized in the art may be suitable for use with the disclosure. Alternatively, a hindered amine radical scavenger can be included in the first reaction component or combined with an UV absorber. The hindered amine free radical scavengers generally recognized in the art contribute to photostabilization of the polyurethane by trapping alkoxy and hydroxy radicals produced by light-induced dissociation of hydroperoxides. The amount of UV absorber in the first component is desirably in the range from about 0.1 weight percent to about 4 weight percent. The amount of hindered amine radical scavenger in the first component in desirably in the range of about 0.1 weight percent to about 2 weight percent. Exemplary UV absorbers include: benzotriazole compound, 5-trifluoromethyl-2-(2-hydroxy-3-alpha-cumyl-5-tert-octylphenyl)-2H-benzotriazole, or combinations thereof. Other exemplary benzotriazoles include: 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole, or combinations thereof. Additional exemplary UV-absorbers include 2(-4,6-diphenyl-1-3,5-triazin-2-yl)-5-hexcyloxy-phenol, and those available from BASF, Florham Park, NJ sold under the trade designations “TINUVIN 1577”, “TINUVIN 405”, and “TINUVIN 900”. In addition, UV-absorber(s) can be used in combination with stabilizers such as hindered amine light stabilizer(s) (HALS) and/or anti-oxidants. Stabilizers can eliminate free radicals produced by photo-oxidation of the polymer. Exemplary HALSs include those available from BASF sold under the trade designations “CHIMASSORB 944”, TINUVIN-292, and “TINUVIN 123”.

Additionally, moisture scavengers, antioxidants, and antifoaming agents can be included with the first reaction component. Conventional compounds of the noted categories generally recognized by those skilled in the art may be suitable for use in the present disclosure to improve the finished properties of the polyurethane. Moisture scavengers are desirably included at levels in the range of about 0.1 weight percent to about 3 weight percent. The antioxidant is desirably included in a range of about 0.1 weight percent to about 2 weight percent. Antifoaming agents are desirably included in an amount from about 0.2 weight percent or less.

In one embodiment, the second component includes a primary aliphatic isocyanate crosslinker, and preferably a primary aliphatic polyisocyanate crosslinker. A primary isocyanate is defined as one having a carbon atom that has an —NCO group and two hydrogen atoms attached to the carbon atom. The primary isocyanate is an important factor in providing a flexible polyurethane that does not exhibit a substantial amount of outgassing. Outgassing can occur when the isocyanate component of the polyurethane undesirably reacts with a source of water or carboxyl groups and not the hydroxyl groups present in the first component.

In the present disclosure, it is preferred that the second reaction component include a primary polyisocyanate in an amount of about 50 weight percent or greater. This generally corresponds to polyisocyanate crosslinking of about 25 weight percent or greater in the cured polyurethane. The primary aliphatic polyisocyanate may be the only isocyanate source in the component or it may be combined with other primary aliphatic isocyanates, such as monomeric isocyanates. The utilization of secondary isocyanates can result in the rigid polyurethanes or polyurethanes which exhibit outgassing. Conventional primary aliphatic polyisocyanate crosslinkers may be suitable for use with the present disclosure. For example, products available under the trade designation DESMODUR XP-7100 and DESMODUR N-3300 from Bayer Chemical of Pittsburgh, PA are two polyisocyanates suitable for use with the disclosure. Additionally, the polyisocyanate may be a blocked polyisocyanate to further enhance the reduction of outgassing in the cured polyurethane. Blocked polyisocyanates will not react until a desired curing temperature is achieved, thereby further preventing the undesired reaction of the isocyanate with water or carboxyl groups. Polyisocyanate levels of at least about 50 weight percent of the total isocyanate present in the second component may substantially reduce outgassing in the cured polyurethane.

The thermoset polyurethane should exhibit good adhesion to the microspheres. In one embodiment, an adhesion promoter is added to the bead bonding reaction mixture to improve adhesion between the microspheres and the bead bonding layer. In one embodiment the microspheres are covalently bonded to the bead bonding layer.

The crosslink density of a polyurethane is calculated by dividing the weight of the reaction components having a functionality of three or greater by the total weight of the polyurethane and multiplying by 100. Generally, rigid polyurethanes have relatively high cross link densities of 30% or higher. In accordance with the present disclosure, the use of a primary aliphatic polyisocyanate results in a flexible polyurethanes having a high crosslink density. When the polyisocyanate content of the second reaction component is about 50 weight percent or greater, crosslink densities are 30 percent or greater, and preferably 40 percent or greater.

The first and second reaction components are combined to form a solvent-free admixture having an NCO:OH ratio of about 0.75 to about 1.25. The reaction components, prior to mixing, are desirably maintained at specified viscosity ranges. The viscosity measurements for the present disclosure were measured on a Brookfield Viscometer model RV with spindle number 4 at about 20 rpm (revolutions per minute). The viscosity of the first component is desirably maintained in the range from about 200 cps to about 5000 cps to be coatable (for example at a temperature of 25° C.). The viscosity of the second reaction component is desirably maintained in the range from about 100 cps to about 5000 cps to be coatable. Upon mixing, the viscosity of the admixture is in the range from about 400 cps to about 5000 cps to be coatable, and desirably in the range from about 600 cps to about 4000 cps.

In one embodiment the reaction mixture may be degassed and/or dried prior to use to remove any dissolved gasses and/or moisture to minimize outgassing and/or bubble formation in the bead bonding layer.

Depending on the process of construction, the above described admixture is, for example, applied onto a monolayer of microspheres such as on a transfer carrier or is disposed onto the elastomeric layer to for the bead bonding layer. The curing of the thermoset polyurethane may be accomplished by heating and/or partially curing the material using conventional curing techniques recognized by those skilled in the art may be suitable for use with the present disclosure, such as applying infrared radiation, heat, and/or use of air ovens at a certain temperature and then completing cure at ambient temperatures.

Generally, the thickness of the bead bonding layer is at least 10, 25, 30, 40, or even 50 micrometers. Generally, the thickness of the bead bonding layer is at most 50, 60, 75, 100, 125, or even 150 micrometers.

### Microsphere Layer

The microsphere layer comprises a plurality of microspheres. The microspheres useful in the present disclosure comprise glass, glass ceramics, ceramics, polymers, metals, and combinations thereof. Glass is an amorphous material, while ceramic refers to a crystalline or partially crystalline material. Glass ceramics have an amorphous phase and one or more crystalline phases. These materials are known in the art.

In some embodiments, the microspheres are glass beads. The glass beads are largely spherically shaped. The glass beads are typically made by grinding ordinary soda-lime glass or borosilicate glass, typically from recycled sources such as from glazing and/or glassware. Common industrial glasses could be of varying refractive indices depending on their composition. Soda lime silicates and borosilicates are some of the common types of glasses. Borosilicate glasses typically contain boria and silica along with other elemental oxides such as alkali metal oxides, alumina etc. Some glasses used in the industry that contain boria and silica among other oxides include E glass, and glass available under the trade designation “NEXTERION GLASS D” from Schott Industries, Kansas City, Missouri, and glass available under the trade designation “PYREX” from Corning Incorporated, New York, New York.

The grinding process yields a wide distribution of glass particle sizes. The glass particles are spherodized by treating in a heated column to melt the glass into spherical droplets, which are subsequently cooled. Not all the particles are perfect spheres. Some are oblate, some are melted together and some contain small bubbles.

In one embodiment, the microspheres are plastic particles. The plastic particles selected should comprise a hardness greater than the substrate surface to protect the underlying substrate surface. One exemplary plastic particle includes polyurethane, polystyrene, acrylic and methacrylic acid ester polymers and copolymers (e.g., poly(methyl methacrylate)), and polyurea spheres.

In one embodiment, the microspheres comprise a surface modification as is known in the art to improve the adhesion of the microspheres to the bead bonding layer. Such treatments include those selected from the group consisting of silane coupling agent, titanate, organo-chromium complex, and the like, to maximize the adhesion of the microspheres to the first polymer layer. Preferably, the coupling agent comprises a nucleophilic group which is present on the surface of the microsphere and can react with the isocyanates in the reaction mixture of the bead bonding layer. Exemplary coupling agents may include aminosilane. Having a nucleophilic group present on the surface of the microsphere will enable the isocyanates from the bead bonding reaction mixture to form covalent bonds, thereby improving the adhesion between the bead bonding layer and the plurality of microspheres.

In one embodiment, the treatment level for such coupling agents is on the order of 50 to 700 parts by weight coupling agent per million parts by weight microspheres. Microspheres having smaller diameters would typically be treated at higher levels because of their higher surface area. Treatment is typically accomplished by spray drying or wet mixing a dilute solution such as an alcohol solution (such as ethyl or isopropyl alcohol, for example) of the coupling agent with the microsphere, followed by drying in a tumbler or auger-fed dryer to prevent the microspheres from sticking together. One skilled in the art would be able to determine how to best treat the microspheres with the coupling agent.

In one embodiment, the microspheres of the present disclosure have a Knoop hardness of at least 1,300 kg/mm², or even 1,800 kg/mm². The “Knoop hardness” as used herein is an indentation of microhardness measured by using a Knoop indenter; it is a value obtained by dividing the applied load with which a rhombic indentation is formed on the surface of a sample, by the projected area of the indentation computed from the long diagonal of the permanent indentation. The method for measuring the Knoop hardness is described in ASTM C849-88 (2011) “Standard Test Method for Knoop Indentation Hardness of Ceramic Whitewares”.

The microspheres for use in the present disclosure are substantially spherical, for example, having a sphericity of at least 80%, 85%, or even 90%, where sphericity is defined as the surface area of a sphere (with the same volume as the given particle) divided by the surface area of the particle, reported as a percentage. In one embodiment, the microsphere layer consists of only particles which are substantially spherical.

Preferable examples of the spherical particles include fused alumina, alumina produced by the Bayer process, zirconia, and eutectic mixtures thereof.

As a method for shaping inorganic particles into spherical ones, it is possible to apply a method in which the above- described inorganic material in an indeterminate form is ground, and melted in a high-temperature oven at a temperature above the melting point thereof, thereby obtaining spherical particles by utilizing the surface tension; or a method in which the above-described inorganic material is melted at a high temperature above the melting point thereof, and the melt is sprayed to obtain spherical particles.

The microspheres useful in the present disclosure may be transparent, translucent, or opaque depending on the desired properties of the resulting article.

In another embodiment, the microspheres have a refractive index of less than 1.30, 1.40, 1.49, 1.50, 1.55, 1.60, 1.70, 1.80, or even 1.90. The refractive index may be determined by the standard Becke line method.

The microspheres are preferably free of defects. As used herein, the phrase “free of defects” means that the microspheres have low amounts of bubbles, low amounts of irregular shaped particles, low surface roughness, low amount of inhomogeneities, low amounts undesirable color or tint, or low amounts of other scattering centers. In one embodiment, the microspheres are not glass bubbles, which are a hollow core encased in a glass sphere.

In some embodiments, a useful range of average microsphere diameters is at least 10, 20, 25, 40, 50, 75, 100, or even 150 µm (micrometers); at most 200, 400, 500, 600, 800, 900, or even 1000 µm. The microspheres may have a unimodal or multi-modal (e.g., a bimodal) size distribution depending on the application.

The microspheres are typically sized via screen sieves to provide a useful distribution of particle sizes. Sieving is also used to characterize the size of the microspheres. With sieving, a series of screens with controlled sized openings is used and the microspheres passing through the openings are assumed to be equal to or smaller than that opening size. For microspheres, this is true because the cross-sectional diameter of the microsphere is almost always the same no matter how it is oriented to a screen opening.

In some embodiments, to calculate the “average diameter” of a mixture of microspheres one would sieve a given weight of particles such as, for example, a 100 gram sample through a stack of standard sieves. The uppermost sieve would have the largest rated opening and the lowest sieve would have the smallest rated opening.

Alternately, average diameter can be determined using any commonly known microscopic methods for sizing particles. For example, optical microscopy or scanning electron microscopy, and the like, can be used in combination with any image analysis software. For example, software commercially available as free ware under the trade designation “IMAGE J” from NIH, Bethesda, Maryland.

In one embodiment, the plurality of microspheres has a difference in size distribution not more than 40% (30% or even 20%) based on the average microsphere diameter.

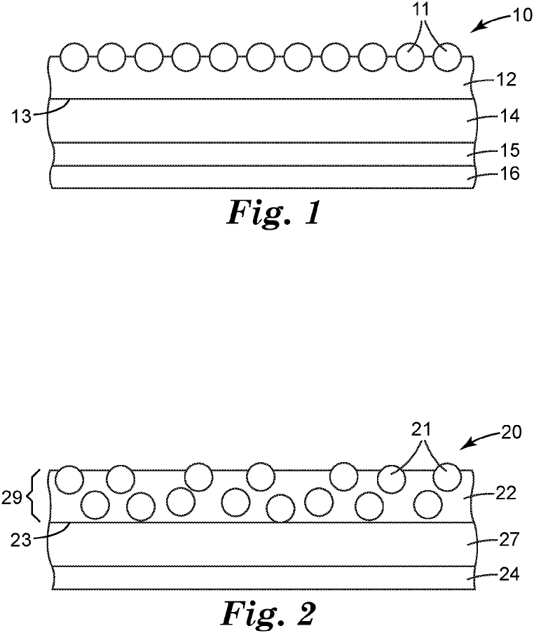

In one embodiment, the plurality of microspheres are arranged in a monolayer (or single layer) across the bead bonding layer as shown in FIG. 1, where multilayered article 10 comprises a microsphere layer which comprises a monolayer of microspheres 11. Bead bonding layer 12 comprises a first major and second major surface 13, which is opposite the first major surface. The plurality of microspheres is partially embedded in the first major surface of the bead bonding layer, which is disposed on an elastomeric layer 14. In one embodiment, as shown in FIG. 1, the construction further comprises adhesive layer 15 and optionally, liner 16.

In another embodiment, the plurality of microspheres are dispersed within the bead bonding layer as shown in FIG. 2. Where multilayered article 20 comprises layer 29, which comprises a plurality of microspheres 21 dispersed in the bead bonding compositon 22. Layer 29 is disposed on elastomeric layer 24.

### Pigment Layer

In one embodiment, the multilayered articles disclosed herein may be used to impart color onto a substrate. Exemplary decorative solids such as pigments, metal flakes, polymeric flakes, glitter, beads, or other materials may be used to enhance the aesthetics of the finished multilayered article. Such decorative solids may be added to the bead bonding layer, the elastomeric layer or an additional layer, such as a pigment layer, may be disposed between the bead bonding layer and the elastomeric layer as shown in layer 27 of FIG. 2. The decorative solids may be included in various amounts to obtain a desired effect to the finished article.

### Adhesive Layer

In some embodiment, the multilayered article of the present disclosure, includes an adhesive layer which extends across and directly contacts the major surface of the elastomeric layer facing away from the primer layer.

In one embodiment, the adhesive layer is a pressure sensitive adhesive and is normally tacky at ambient conditions. Suitable pressure sensitive adhesives can be based on polyacrylates, synthetic and natural rubbers, polybutadiene and copolymers or polyisoprenes and copolymers. Silicone based adhesives such as polydimethylsiloxane and polymethylphenylsiloxane may also be used.

Particularly preferred pressure sensitive adhesives include polyacrylate-based adhesives, which can display advantageous properties as high degrees of clarity, UV-stability and aging resistance. Polyacrylate adhesives that can be used in surfacing film applications are described, for example, in U.S. Pat. Nos. 4,418,120 (Kealy et al.); RE24,906 (Ulrich); 4,619,867 (Charbonneau et al.); 4,835,217 (Haskett et al.); and International Publication No. WO 87/00189 (Bonk et al.).

Preferably, the polyacrylate pressure sensitive adhesive comprises a crosslinkable copolymer of a C₄-C₁₂ alkyl acrylate and an acrylic acid. The adhesive can be used with or without a crosslinker. Useful crosslinking reactions include chemical crosslinking and ionic crosslinking. The chemical crosslinker could include polyaziridine and/or bisamide and the ionic crosslinker may include metal ions of aluminum, zinc, zirconium, or a mixture thereof. A mixture of chemical crosslinker and ionic crosslinker can also be used. In some embodiments, the polyacrylate pressure sensitive adhesive includes a tackifier such as rosin ester. Adhesives useful in the present disclosure may also contain additives such as ground glass, titanium dioxide, silica, glass beads, waxes, tackifiers, low molecular weight thermoplastics, oligomeric species, plasticizers, pigments, metallic flakes and metallic powders as long as they are provided in an amount that does not unduly degrade the quality of the adhesive bond to the surface.

As an alternative to pressure sensitive adhesives, the adhesive layer may be a hot melt adhesive, which is not tacky at room temperature but becomes tacky upon heating. Such adhesives include acrylics, ethylene vinyl acetate, and polyurethane materials.

Generally, the adhesive layer can have a thickness of at least 15, 20, 25, 30, or even 40 micrometers; and at most 50, 60, 75, or even 90 micrometers.

For certain applications, it may be desirable for the adhesive to be repositionable, at least initially, so that the sheet can be adjusted to fit at a desired place before a permanent bond is formed. Such repositionability may be achieved by providing, for example, a layer of minute glass bubbles on the adhesive surface as disclosed in U.S. Pat. No. 3,331,729 (Danielson et al.).

### Optional Liner

If a pressure sensitive adhesive is used, a liner may be disposed onto the pressure sensitive adhesive opposite the elastomeric layer. A liner is a temporary support that is not intended for final use of the adhesive article and is used during the manufacture or storage to support and/or protect the adhesive layer. A liner is removed from the adhesive layer prior to use. Such liners are known in the art.

Typically, a liner includes a support such as a polymeric film (such as a polyolefin or polyester) or a paper (such as crepe or Kraft paper), which is coated with a release agent. Such release agents are known in the art and are described, for example in “Handbook of Pressure Sensitive Adhesive Technology,” D. Satas, editor, Van Nostrand Reinhold, New York, N.Y., 1989, pp. 585-600. Examples of release agents include carbamates, silicones and fluorocarbons.

In one embodiment, the 180 degree peel force to separate the adhesive layer (e.g., a (meth)acrylic pressure sensitive adhesive) from the liner is at least 0.1, 0.2, 0.3, 0.4, 0.5, or even 0.6 N/mm and at most 0.7, 0.8, 0.9, or even 1.0 N/mm at a rate of 12 in/min (30 cm/min).

### Method of Making

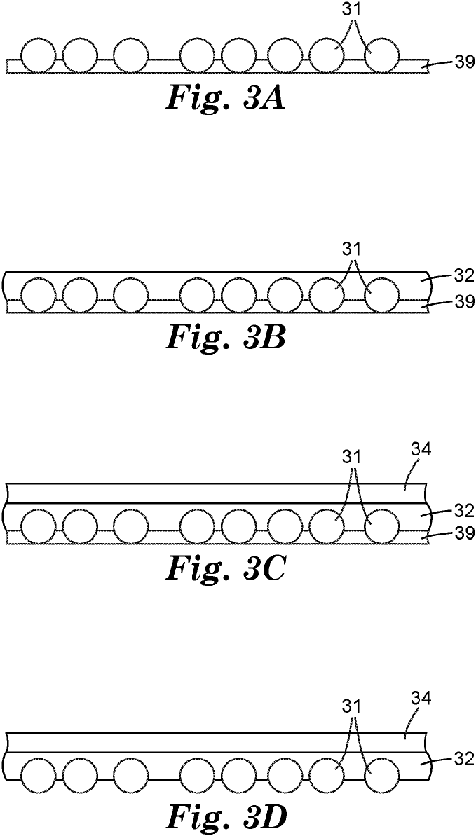

In one embodiment, the articles disclosed herein may be made via a transfer process wherein the plurality of microspheres is held in a transfer polymer which is then used to transfer the plurality of microspheres onto the bead bonding layer. Such a transfer process is shown in FIGS. 3A-3D. FIG. 3A depicts a transfer carrier comprising a monolayer of microspheres 31 partially embedded in transfer polymer 29. Typically, the transfer polymer is supported on a transfer support (not shown) to provide handling ability to the transfer carrier. Such transfer supports include for example, a polyester layer. Such a transfer carrier is described for example, in paragraphs [0021]- [0029] of U.S. Pat. Publ. No. 2015/0010723 (Krishnan et al.); and paragraphs [00130]-[0139] of WO 2017/172888 A1 (Walker et al.). In one embodiment, a transfer polymer is disposed onto a transfer support layer and coated with microspheres as discussed in the Example Section below. In another embodiment, a polymer disposed on a support can be commercially obtained (such as from Felix Schoeller Group, Pulaski, NY,) and the microspheres are then coated onto the commercial product.

In constructions comprising a monolayer of microspheres, the plurality of microspheres may be randomly-distributed and closely packed (i.e., generally there is not enough space between neighboring microspheres to place another microsphere) on the transfer carrier. In another embodiment, the monolayer of microspheres comprises a plurality of microspheres patterned on the surface of the transfer carrier and thus, patterned on the resulting finished article. WO Publ. No. 2017/106239 (Clark et al.), incorporated herein by reference, discloses a monolayer of microspheres arranged in a microscopic periodic pattern, meaning that the microspheres are arranged in a pattern on the microscopic level (i.e., a pattern in relation to the other microspheres) and the pattern is periodic (i.e., not random and having an order to it). The unit repeat, i.e., the area consuming the repeat pattern may have a triangular, quadrilateral (e.g., squares, rhombus, rectangle, parallelogram), hexagonal, or other repeat pattern shape, which may be symmetric or asymmetric in nature. Appl. No. PCT/US2017/024711 (Walker et al.) incorporated herein by reference, discloses a monolayer of randomly distributed microspheres arranged in a predetermined pattern atop a surface. The predetermined pattern comprises at least one of (i) a plurality of the first areas, (ii) a plurality of the second areas, and (iii) combinations thereof. In one embodiment, the plurality of microspheres within the second area are closely packed. Exemplary shapes of the first and second areas include lines (or stripes), triangular, hexagonal, rectangular, or oblong shapes. The patterns may be pseudo-random, meaning that pattern may appear random, but it is not. Pseudo-random patterns are typically less noticeable to the naked eye than a regular pattern.

As shown in FIG. 3B, bead bonding layer 32 is applied to the transfer carrier, such that the plurality of microspheres is positioned between bead bonding layer 32 and transfer polymer 39. The bead bonding layer is made from a liquid reaction mixture and thus, can be coated using any known technique. Suitable techniques include, for example, coating or extruding.

In an exemplary extrusion process, the reaction mixture components of the bead bonding layer are initially mixed into two separate parts to prevent premature reaction. One part can be prepared by first mixing the polyol components with the hydroxy-functional silicone poly(meth)acrylate, and any optional additives. The other part contains the isocyanate component along with any solvent or optional additives. The first and second parts are then mixed in appropriate amounts to obtain a desired NCO:OH ratio. In these embodiments, the NCO:OH ratio can be selected to be between 0.75 and 1.25.

Once mixed, the bead bonding reaction mixture can be coated between the transfer carrier comprising the microspheres and the elastomeric layer to adhere to microspheres to the elastomeric layer. The coating can be made using conventional equipment such as a knife coater, roll coater, reverse roll coater, notched bar coater, curtain coater, rotogravure coater, or rotary printer. Coatings can be hand spread or automated and may be carried out according to either a batch or continuous process. The viscosity of the bead bonding reaction mixture can be adjusted as needed to suit the type of coater used. Once coated, the layers are laminated together to form the multilayer article.

After coating, the bead bonding layer may be heated to thermally activate the curing reaction between the polyol and isocyanate and partially cure the bead bonding layer. In one embodiment, the reaction mixture used to form the bead bonding layer is substantially free (i.e., less than 1, 0.5, 0.1, or even 0.05% by wt or even none) of a photoactive curing agent. In some embodiments, the bead bonding layer is 30% to 90% cured followed by ambient temperature cure.

An oven can be used to partially cure the bead bonding layer. Commonly, the drying/curing step takes place in air. Where a continuous process is used, these processes can act upon a moving web. In an exemplary continuous process, a 0.0076 centimeter (0.003 inch) thick wet coating could have a solids content of about 45%, and be dried and cured using a temperature profile with a residence time of 2 minutes at 80° C. followed by a residence time of 10 minutes at 125° C.

In general, the bead bonding layer is preferably dried and/or cured at predetermined temperatures of from at least 25, 20, 35, 40, 50, or even 60° C. to at most 80, 90, 100, 110, 120, 130, 140, or even 150° C. Residence time at a given temperature, while highly dependent on the temperature, can be from at least 5, 10, 20, 30, 45, or even 60 seconds to at most 120, 150, or even 180 seconds. The bead bonding layer is preferably subjected to residence times and temperatures, or temperature ranges, that balance curing effectiveness with overall throughput and energy efficiency.

Depending on the bead bonding reaction mixture and the cure conditions, the cured bead bonding layer may not have a homogeneous thickness across the layer. For simplicity, the effective thickness of the bead bonding layer is referred to. An effective thickness of the bead bonding layer is the average theoretical thickness of the bead bonding layer assuming a linear profile. In one embodiment, the effective thickness of the bead bonding layer is at least 12, 15, 20, 25, 30, 35, or even 40 micrometers; and at most 50, 60, 75, or even 85 micrometers. In one embodiment, the bead bonding layer should be thick enough to strongly attach the microspheres, but not so thick that it may crack upon bending (such as rolling up the finished article or bending the finished article around a curved object).

As shown in FIG. 3C, elastomeric layer 34 is disposed onto the exposed major surface of bead bonding layer 32. In one embodiment, the bead bonding layer has been fully cured. In some embodiments, the elastomeric layer can be melt processed and coated onto the bead bonding layer from the melt. In alternative embodiments, the elastomeric layer can be melt processed and formed into a uniform sheet separately, then subsequently hot laminated with the bead bonding layer.

In one embodiment, elastomeric layer 34 can be formed by extruding. An example of a suitable die includes a coat hanger die. The uniform film can be further pressed by a cold roller which thermally quenches the reaction shaping the polyurethane, thereby solidifying the polyurethane thermoplastic elastomer. The extrusion can occur at any suitable temperature. For example, the temperature can be in a range of from 40, 50, 60, 70, 80, 90, or even 100° C. to at most 175, 200, 210, 220, or even 230° C.

Additional layers can be attached to the multilayered article including an adhesive layer and a liner, which are not shown in FIG. 3C. For example, an adhesive layer can be directly coated onto the remaining layers of the article or formed into an adhesive film and then laminated to the bulk layer in a subsequent step. In the latter case, a sacrificial release liner is typically placed in contact with the adhesive layer to facilitate web handling and storage. To apply pressure-sensitive adhesive layer to the elastomeric layer it can be desirable to corona treat (e.g., air or N₂ corona treatment) and thermally laminate a major surface of the extruded elastomeric layer to be bonded to, for example, a pressure-sensitive adhesive layer. To accomplish this, the major surface of elastomeric layer, which is not in contact with the bead bonding layer, is exposed and then corona treated. If a hot laminating process is used (e.g., elastomeric layer is extruded onto a releasable carrier web or liner), the carrier web or liner can be first stripped off the elastomeric layer.

Preferably, the bead bonding reaction mixture is coated or extruded directly onto elastomeric layer to achieve good adhesion between the layers. For example, the bead bonding reaction mixture is coated or extruded between the microsphere side of the transfer carrier and the elastomeric layer as described above. The layers are laminated together between two nip surfaces in about a room or ambient temperature environment (e.g., the layers are not kept in an intentionally heated environment during the laminating process). The nip surfaces can be two nip rollers, a stationary nip surface (e.g., a low friction surface of a flat or curved plate) and a nip roller, or two stationary nip surfaces. Alternatively, the multilayered articles disclosed herein may be made by dispersing the plurality of microspheres into the bead bonding reaction mixture (e.g., a polyurethane admixture) used to make the bead bonding layer. This dispersion may then be coated or extruded as described above for the bead bonding reaction mixture. In one embodiment, this dispersion may be coated or extruded onto the elastomeric layer or optional pigment layer and cured as described above.

Alternatively, the multilayered articles disclosed herein may be made by pressing the plurality of microspheres into the bead bonding layer. For example, the bead bonding reaction mixture is coated or extruded onto the elastomeric layer as described above and the plurality of microspheres is subsequently and/or simultaneously coated (e.g., cascade coated) with the plurality of microspheres A a nip roller may be used to press the microspheres directly into the bead bonding layer which is uncured or at least partially cured. The construction may then be subsequently cured as described above.

In one embodiment, the transfer polymer layer 39 is removed from bead bonding layer 32, resulting in the plurality of microspheres to be transferred to the bead bond layer and ultimately resulting in microsphere-coated article 30 as shown in FIG. 3D. The transfer polymer layer (and the transfer carrier) is typically removed after the adhesive layer and liner have been assembled onto the multilayered article. Typically, at least one rigid layer needs to be part of the multilayered article during construction for structural support to enable handling of the article during further processing. Typically, this rigid layer is either a release liner attached to an adhesive layer of the article or is part of the transfer carrier. The transfer carrier (comprising the transfer polymer and corresponding transfer support layer) may be removed during manufacture or by the end-user just prior to application of the multilayered article onto a surface to be protected.

### Additional Layers

In addition to the elastomeric layer, bead bonding layer, and microspheres previously mentioned, the resulting article of the present disclosure may also comprise additional layers to impart desirable characteristics into the article.

In one embodiment, a nanoparticle-containing undercoat may be applied between the microsphere layer and the bead bonding layer to provide anti-soiling properties as taught in U.S. Pat. Publ. No. 2015-0343502 (Clark et al.), incorporated herein by reference.

In one embodiment, the multilayered article can comprise inks such that it also has a graphic function. Typically, if a graphic image is desired it is provided separately on the surface of the bead bonding layer opposite the microsphere layer by at least one colored polymeric layer. The optional colored polymeric layer may, for example, comprise an ink. Examples of suitable inks for use in the present disclosure include but are not limited to those selected from at least one of pigmented vinyl polymers and vinyl copolymers, acrylic and methacrylic copolymers, urethane polymers and copolymers, copolymers of ethylene with acrylic acid, methacrylic acid and their metallic salts, and blends thereof. The colored polymeric layer, which can be an ink, can be printed via a range of methods including, but not limited to screen printing, flexographic printing, offset printing, lithography, transfer electrophotography, transfer foil, and direct or transfer xerography. The colored polymeric layer may be transparent, opaque, or translucent.

In one embodiment, the multilayered article comprising a thin coating of metal (e.g., silver or aluminum) on the underside of the microspheres between the microspheres and the bead bonding layer to act as a mirror for retroreflection.

### Multilayered Article

The multilayered articles of the present disclosure comprise a plurality of microspheres. In one embodiment, the plurality of microspheres are arranged in a monolayer (i.e., a single layer) on the surface of the bead bonding layer. The plurality of microspheres are partially embedded into the bead bonding layer, which means that the microspheres are (on average) embedded approximately at least 50, 55, 60, 65, or even 70% and no more than 80% of the microsphere diameter into the bead bonding layer, however, a portion (for example, at least 10, 20, or even 25%) of each of the microspheres projects outwardly from the surface of the bead bonding layer. In another embodiment, the plurality of microspheres are dispersed within the bead bonding layer. The plurality of microspheres may be homogeneously on non-homogeneously dispersed across the thickness of the bead bonding layer. Preferably, the plurality of microspheres is non-homogenously dispersed with a majority of the microspheres are located toward the exposed surface of the multilayered article (in other words, away from the elastomeric layer). Preferably, at least a portion of the plurality of microspheres is partially embedded in bead bonding layer, such that this portion of the microspheres project outwardly from the surface of the bead bonding layer.

Depending on the arrangement (for example, random versus patterned) of the plurality of microspheres on the surface on the bead bonding layer, the plurality of microspheres cover more than 10, 15, 20, 25, or even 30%; and less than 35, 40, 45, 50, 55, 60, 65, 70 or even 75% of the surface of the bead bonding layer. In one embodiment, the plurality of microspheres are randomly-distributed and closely packed (i.e., generally there is not enough space between neighboring microspheres to place another microsphere) and the plurality of microspheres covers at least 65% and at most 80% of the first surface. Generally, it is preferably that there is less than one average microsphere diameter between adjacent microspheres to achieve adequate abrasion resistance and minimize visual defects.

In one embodiment, the surface of the finished article can be abraded to truncate the exposed top surfaces of the plurality of microspheres in the microsphere monolayer. Such a technique is described in WO 2019/046407 (Clark et al.), herein incorporated by reference.

### Applications and Properties

The provided multilayered articles may be useful in paint protection and paint replacement applications. These films can be applied to any of a wide variety of substrates. Such substrates may be flat or curved. When it is desired to adhere these articles to such curved surfaces, it is preferable that the article has sufficient flexibility to conform to the surface of the substrate without delaminating at the edges or wrinkling.

In some embodiments, the provided article is applied for protection to the exterior surfaces of automobiles (such as bumper facia, pillar posts, rocker panels, wheel covers, headlights, door panels, trunk and hood lids, mirror housings, dashboards, floor mats, and door sills), trucks, motorcycles, trains, airplanes (such as propeller blade, wing, or fuselage), rotorcraft, marine vessels (such a hull, transom, or bulwark), and snowmobiles. In alternative embodiments, the articles of the present disclosure can be applied to surfaces of structures other than vehicles, such as fixtures, buildings and architectural surfaces. Applications of these films may be either indoor or outdoor in nature.

In an exemplary method of application, the multilayered article disclosed herein can be mounted to a suitable substrate by simultaneously peeling away the release liner from the adhesive layer while applying the film onto the substrate in a single continuous motion.

Advantageously, the bead bonding layer provides a combination of desirable optical and mechanical properties rendering it especially suitable as an outermost layer in protective film applications.

In one embodiment, the article of the present disclosure is durable, meaning that it has abrasion and/or scratch resistance. Abrasion resistance can be measured using a rotary Taber abraser and visually inspecting the samples for damage. In one embodiment, the decorative articles of the present disclosure have an abrasion resistance with little to no visual abrasion. The scratch resistance can be measured by pencil hardness. In other words, at which hardness the pencil scratches the surface. In one embodiment, the decorative articles of the present disclosure have a pencil hardness value of at least 6 H, 8 H, or even 10 H at a force of 2.5 Newtons. In one embodiment, the articles of the present disclosure have a pencil hardness value of at least 3 H, 5 H, 6 H, 8 H, 9 H, or even 10 H at a force of 7.5 Newtons.

In one embodiment, the articles of the present disclosure do not show fingerprints.

The articles of the present disclosure may or may not be retroreflective. Typically to be retroreflective, a thin layer of metal is used in the construction behind the embedded portion of the microspheres to achieve retroreflection. Retroreflectivity of an article can be expressed in terms of its coefficient of retroreflectivity (Rₐ)

$${\text{R}}_{\text{a}} = {\text{E}}_{\text{r}} {\text{*d}}^{2} / {\text{E}}_{\text{s}} \text{*A}$$

where:
Eᵣ = illumination incident upon the receiver
Eₛ = illumination incident upon a plane perpendicular to the incident ray of the specimen position, measured in the same units as Eᵣ
d = distance from the specimen to the projector
A = area of the test surface

The coefficient of retroreflectivity (Rₐ) is further described in U.S. Pat. No. 3,700,305 (Bingham). In one embodiment, the articles of the present disclosure have a coefficient of retroreflection of less than or equal to 10, 5, 1, 0.5, or even 0.3 candelas/lux/square meter measured at 0.2° observation angle and 5° entrance angle following ASTM E810-03(2013) “Standard Test Method for Coefficient of Retroreflection of Retroreflective Sheeting Utilizing the Coplanar Geometry”, meaning that they are not retroreflective. In one embodiment, the articles of the present disclosure have a coefficient of retroreflection of less than or equal to 50, 25, 20, 15, 10, 5, 1, or even 0.5 candelas/lux/square meter measured at 0.2° observation angle and -4.0° entrance angle, meaning that they are not retroreflective.

In one embodiment, the multilayered article withstands weathering. For example, the article is impermeable to water (such as rain and moisture), stable under exposure to ultra violet light and/or durable. For example, weather testing can include placing panels of the multilayered article in the outside environment angled for example at 45 degrees relative to the ground in Arizona and 5 degrees relative to the ground in Florida. The multilayered articles with the layer of microspheres facing outward, are exposed to the elements (e.g., rain, sun, wind, etc.) for 1 to 4 years.

In one embodiment, the multilayered article of the present disclosure heat stable. Heat stability may be determined by adhesively attaching the multilayered article to a white painted panel and heating the sample in an oven at 80° C. for 7 days. The change in color is monitored using CIELAB color space, where L* defines the lightness from 0 (black) to 100 (white), a* defines red/green, and b* defines blue/yellow. In optical applications, the b* parameter is selected since it is a measure of the blue-yellow as defined in the CIE (International Commission on Illumination 1976 Color Space, with the lower the b* value the more desirable. In one embodiment, the articles of the present disclosure after heat aging have a change in delta E* (total color change) or delta b* of less than 2, 1, or even 0.5.

In one embodiment, the multilayered article of the present disclosure is ultraviolet (UV) resistant. UV resistance may be determined in a similar manner as described above for heat stability, except that the sample is exposed to UV radiation for a given time period. In one embodiment, the articles of the present disclosure upon exposure to UV radiation have a change in delta E* (total color change) or delta b* of less than 2, 1, or even 0.5.

In one embodiment, the multilayered article of the present disclosure is resistant to staining from asphalt. Asphalt staining resistance may be determined in a similar manner as described above for heat stability, except that the sample is exposed to asphalt. In one embodiment, the articles of the present disclosure upon exposure asphalt have a change in delta E* (total color change) or delta b* of less than 2, 1, or even 0.5.

Exemplary embodiments of the present disclosure, include, but are not limited to the following:

Embodiment 1. A multilayer article comprising:
(a) a microsphere layer comprising a plurality of microspheres;
(b) a bead bonding layer comprising a first major surface and a second opposing major surface wherein the plurality of microspheres is at least partially embedded in the first major surface of the bead bonding layer, and wherein the bead bonding layer comprises a thermoset polyurethane, and wherein the thermoset polyurethane is derived from one or more liquid polyols; and
(c) an elastomeric layer disposed on the second opposing major surface of the bead bonding layer.

Embodiment 2. The multilayer article of embodiment 1, wherein the liquid polyol has a viscosity of at most 6000 cP at 50° C.

Embodiment 3. The multilayer article of any one of the previous embodiments, comprising a pigmented layer disposed between the second opposing major surface of the bead bonding layer and the elastomeric layer.

Embodiment 4. The multilayer article of any one of the previous embodiments, wherein the bead bonding layer comprises a pigment.

Embodiment 5. The multilayer article of any one of the previous embodiments, wherein the elastomeric layer comprises a pigment.

Embodiment 6. The multilayer article of any one of the previous embodiments, wherein the pigment comprises at least one of metallic flake or pearlescent particles.

Embodiment 7. The multilayer article of any one of the previous embodiments, wherein at least one of the one or more liquid polyols comprise at least 3 hydroxyl groups and has an equivalent weight of 28 to 3000.

Embodiment 8. The multilayer article of any one of the previous embodiments, wherein the thermoset polyurethane comprises at least 10 weight percent of the liquid polyol.

Embodiment 9. The multilayer article of any one of the previous embodiments, at least one of the one or more liquid polyols is selected from a polyester polyol.

Embodiment 10. The multilayer article of any one of the previous embodiments, wherein the elastomeric layer comprises a reaction product of a reaction mixture comprising:
a diisocyanate;
a polymeric diol; and
a diol chain extender.

Embodiment 11. The multilayered article of embodiment 10, wherein the diisocyanate is chosen from dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluylene diisocyanate, diphenylmethane 4,4′-diisocyanate, 1,4-diisocyanatobutane, 1,8-diisocyanatooctane, or a mixture thereof. Embodiment 12. The multilayered article of any one of embodiments 10-11, wherein the polymeric diol is selected from at least one of a polyester diol, a polycaprolactone diol, a polyether diol, a polycarbonate diol, and a polyolefin diol.

Embodiment 13. The multilayered article of embodiment 12, wherein the polyester diol is a product of a reaction of a diol with one or more compounds selected from polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, poly(1,4-butylene adipate), poly(1,6-hexamethylene adipate), poly(ethylene-adipate), mixtures thereof, and copolymers thereof.

Embodiment 14. The multilayered article of embodiment 13, wherein the reaction comprises a reaction between at least one of: a plurality of carboxylic acids; and a carboxylic acid and a diol.

Embodiment 15. The multilayered article of embodiment 14, wherein the carboxylic acid is chosen from glycolic acid, lactic acid, succinic acid, 3-hydoxybutanoic acid, 3-hydroxypentanoic acid, terephthalic acid, naphthalene dicarboxylic acid, 4-hydroxybenzoic acid, 6-hydroxynaphtalane-2-carboxylic acid, oxalic acid, malonic acid, adipic acid, pimelic acid, ethanoic acid, suberic acid, azelaic acid, sebacic acid, glutaric acid, dedecandioic acid, brassylic acid, thapsic acid, maleic acid, fumaric acid, glutaconic acid, 2-decenedioic acid, muconic acid, glutinic acid, citraconic acid, mesaconic acid, itaconic acid, malic acid, aspartic acid, glutamic acid, tartonic acid, tartaric acid, diaminopimelic acid, saccharic acid, mexooxalic acid, oxaloacetic acid, acetonedicarboxylic acid, arbinaric acid, phthalic acid, isophthalic acid, diphenic acid, 2,6-naphtalenedicarboxylic acid, or a mixture thereof.

Embodiment 16. The multilayered article of any one of embodiments 10-15, wherein the diol chain extender is chosen from ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, or a mixture thereof.

Embodiment 17. The multilayered article of any one of embodiments 10-16, wherein the diol chain extender has a weight-average molecular weight of less than about 250 daltons.

Embodiment 18. The multilayer article of any one of the previous embodiments, wherein the elastomeric layer has thickness of at least 50 micrometers and at most 400 micrometers.

Embodiment 19. The multilayered article of any one of the previous embodiments, wherein the multilayered article is stable to UV radiation, heat or combinations thereof.

Embodiment 20. The multilayered article of any one of the previous embodiments, wherein the thermoset polyurethane is a reaction product of:
an isocyanate; and
a liquid polyol.

Embodiment 21. The multilayered article of embodiment 20, wherein the isocyanate is a primary aliphatic isocyanate.

Embodiment 22. The multilayered article of any one of the previous embodiments, wherein the thermoset polyurethane is derived from a solventless polyurethane.

Embodiment 23. The multilayer article of any one of the previous embodiments, wherein the plurality of microspheres are covalently bonded to the bead bonding layer.

Embodiment 24. The multilayer article of any one of the previous embodiments, wherein the plurality of microspheres covers more than 20% and less than 60% of the surface of the bead bonding layer.

Embodiment 25. The multilayer article of any one of the previous embodiments, wherein the plurality of microspheres has an average diameter of 20 to 200 micrometers.

Embodiment 26. The multilayer article of any one of the previous embodiments, wherein the refractive index of the plurality of microspheres is less than 1.90.

Embodiment 27. The multilayer article of any one of the previous embodiments, wherein the plurality of microspheres is embedded on average to at least 55% of the average diameter of the microspheres.

Embodiment 28. The multilayer article of any one of the previous embodiments, wherein the surface of the plurality of microspheres comprises a nucleophilic group.

Embodiment 29. The multilayer article of embodiment 28, wherein the nucleophilic group is an amino group.

Embodiment 30. The multilayer article of any one of embodiments 1-27, wherein the plurality of microspheres do not comprise a surface modification.

Embodiment 31. The multilayer article of any one of the previous embodiments, wherein the bead bonding layer is in intimate contact with the elastomeric layer.

Embodiment 32. The multilayer article of any one of the previous embodiments, comprising an adhesive layer disposed along a major surface of the elastomeric layer, opposite the bead bonding layer.

Embodiment 33. The multilayer article of embodiment 30, wherein the adhesive is a (meth)acrylic pressure sensitive adhesive.

Embodiment 34. The multilayer article of embodiment 31, further comprising a disposable liner disposed on the (meth)acrylic pressure sensitive adhesive opposite the elastomeric layer.

Embodiment 35. The multilayer article of embodiment 32, wherein the disposable liner comprises a silicone coated polyester or a silicone coated paper.

Embodiment 36. The multilayer article of any one of embodiments 32-33, wherein the disposable liner has a peel force of 0.1 to 1.0 N/mm.

Embodiment 37. The multilayer article of any one of the previous embodiments, wherein the article can be shaped.

Embodiment 38. A method of making a multilayered article, the method comprising:
providing an elastomeric layer;
disposing onto a first major surface of the elastomeric layer a solventless curable polyurethane coating layer and a plurality of microspheres to form a curable multilayered article; and then curing the curable multilayered article.

Embodiment 39. The method of embodiment 38 wherein the curable multilayered article is formed by obtaining the elastomeric layer with the solventless curable polyurethane coating layer disposed thereon; and

contacting the plurality of microspheres to the solventless curable polyurethane coating layer.

Embodiment 40. The method of embodiment 38 wherein the curable multilayered article is formed by obtaining a solventless mixture comprising a curable polyurethane solution with the plurality of microspheres dispersed therein; and

coating the elastomeric layer with the solventless mixture to form a curable multilayered article.

Embodiment 41. The method of embodiment 38 wherein the curable multilayered article is formed by obtaining a transfer sheet, wherein the transfer sheet comprises a transfer polymer layer having a plurality of microspheres partially embedded thereon;

coating the partially embedded plurality of microspheres with the solventless curable polyurethane coating layer; and then contacting the solventless curable polyurethane coating layer with the elastomeric layer.

Embodiment 42. The method of any one of embodiments 38-41, wherein the elastomeric layer comprises a reaction product of a reaction mixture comprising:
a diisocyanate;
a polymeric diol; and
a diol chain extender.

Embodiment 43. The method of any one of embodiments 38-42, wherein the solventless curable polyurethane coating layer comprises:
an isocyanate; and
a liquid polyol.

Embodiment 44. The method of any one of embodiments 38-43, wherein the solventless curable polyurethane coating layer comprises less than 5 % by weight of a solvent.

Embodiment 45. The method of any one of embodiments 38-44, wherein the elastomeric layer comprises a polyurethane thermoplastic elastomer.

Embodiment 46. The method of embodiment 44, wherein the polyurethane thermoplastic elastomer is extruded onto the solventless curable polyurethane coating layer.

Embodiment 47. The method of any one of embodiments 38-46, further comprising disposing an adhesive layer on the elastomeric layer opposite the solventless curable polyurethane coating layer.

Embodiment 48. The method of embodiment 47, further comprising disposed a liner on the adhesive layer opposite the elastomeric layer.

Embodiment 49. Use of the multilayer article according to any one of embodiments 1-37 in a motor vehicle, aircraft, or watercraft.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

TABLE 1

Materials

| | |
|---|---|
| Chemical/Trade Designation | Description |
| FOMREZ 55-225 | Hydroxyl terminated saturated linear polyester which is a poly (neopentyl adipate) glycol, having a hydroxyl number of 220-230, available from Fomrez, Middlebury, CT |
| FOMREZ 55-112 | Hydroxyl terminated saturated linear polyester which is a poly (neopentyl adipate) glycol, having a hydroxyl number of 110-114, available from Fomrez, Middlebury, CT |
| FOMREZ 44-111 | Hydroxyl terminated saturated linear polyester which is a poly (butylene adipate) glycol, having a hydroxyl number of 110-114, Polyester polyol available from Fomrez, Middlebury, CT |
| CAPA 3031 | Low molecular weight trifunctional caprolactone polyol available from Ingevity, North Charleston, NC |
| TINUVIN-292 | A liquid hindered amine mixture of Bis (1, 2, 2, 6, 6-pentamethyl-4-piperidyl) sebacate and Methyl 1, 2, 2, 6, 6-pentamethyl-4-piperidyl sebacate available from BASF, Florham Park, NJ |
| TINUVIN-405 | UV light absorber (2-Hydroxyphenyl-s-triazine) available from BASF |
| TINUVIN-571 | UV light stabilizer (2-(benzotriazol-2-yl)-6-dodecyl-4-methylphenol) available from BASF |
| DESMODURN 3300 | Solvent-free aliphatic polyisocyanate (HDI trimer) available from Covestro, Leverkusen, Germany |
| DESMODUR XP 2580 | Aliphatic polyisocyanate based on HDI available from Covestro, Leverkusen, Germany |
| ALBERDINGK U933 | Water-based, polycarbonate-based polyurethane dispersion available from Alberdingk Boely, Greensboro, NC |
| AMP-95 | Aminomethyl propanol available from Angus Chemical Co., Buffalo Grove, IL |
| NEOCRYL CX-100 | Polyaziridine available from DSM Coating Resins, LLC, Wilmington, MA |
| UVINUL N539 | 2-ethylhexyl ester of diphenyl acrylic acid, a UV light absorber available from BASF, Florham Park, NJ |
| SILWET L-7607 | Organosilicone surface tension reducing agent available from Momentive Perfomance Materials Inc., Waterford, NY |
| TRITON GR-7M | Sulfosuccinate-type anionic surfactant available from DOW Chemicals, Midland, MI |
| A1100 | Gamma-aminopropyltrimethoxysilane, a clear liquid coupling agent, available under the trade designation SILQUEST A1100 from Momentive Performance Materials Incorporated, Columbus, OH. |
| Borosilicate glass powder | Milled borosilicate glass powder having a size distribution of less than 200 mesh and density of 2.23 grams/cubic centimeter, available under the trade designation “PYREX 7740” from Strategic Materials Incorporated, Houston TX. |
| Butyl carbitol | Available from Eastman Chemical Co., Kingsport, TN |
| 1,4 butanediol | Available from BASF |
| DESMODUR W | Bis(4-isocyantocyclohexyl) methane available from Bayer, Leverkusen, Germany |
| IRGANOX-1076 | Antioxidant, Octadecyl-3-(3,5-di-tert. Butyl-4-hydroxyphenyl)-propionate available from BASF |
| DABCO T-12 | Dibutyl tin dilaurate catalyst available from Air Products, Detroit, MI |

### Heat Aging Test

All the examples and comparative examples were adhesively attached using the acrylic pressure sensitive adhesive layer to the front of a clear coat white coat painted panel (RK59466 available from ACT Painted Panels LLC, Hillsdale, MI). A Hunterlab UltraScan Pro Spectrophotometer (Hunter Associates Laboratory Inc., Reston, VA) was placed in front of the monolayer of microspheres in the construction and used to determine the CIELAB color space. The sample (still adhered to the painted panel) was placed in an oven held at 80° C. for 7 days. The sample was removed from the oven and cooled and the CIELAB color space was determined. The difference in L*, a*, b* and the E* was determined and reported.

### Tabor Abrasion Test

The abrasion test was conducted according to the standard procedure described in ASTM 1044-13. The 5130 Abraser obtained from Taber Industry, North Tonawanda, NY was used to conduct the test. A harsh abrading wheel CS17 (from the same company) along with a 500 gram weight load was used. The test was run 200 cycles. After the test, haze was visually inspected.

### Gravel Resistance

The gravel resistance test was conducted according to the standard procedure described in SAE (Society of Automotive Society) J400 at -30° C. A Gravel-O-Meter machine from The Q-Lab Corporation, Westlake, OH was used. The bead film was applied on an ACT clear coat white color coat painted panel and conditioned at -30° C. for 24 hours. The panel was then given the gravel test with one pint of gravel at 70 psi. After the gravel test, the panels were visually inspected.

### Transfer Carrier

The transfer carrier comprising a monolayer of microspheres can be obtained as follows: Borosilicate glass powder was flame treated by passing it through a hydrogen/oxygen flame at a rate of 3 grams/minute two times, then collected in a stainless steel container whereupon metallic impurities were removed using a magnet. The resulting solid glass microspheres were treated with 600 ppm of A1100 in the following manner. The silane was dissolved in water, then added to the microspheres with mixing, air dried overnight, followed by drying at 110° C. for 20 minutes. The dried, silane treated microspheres were then sieved to remove any agglomerates and provide beads having a size of 75 micrometers or less and which were free flowing. The resulting transparent silane treated microspheres were cascade coated using a mechanical sifter onto a transfer carrier comprising a polyethylene coated polyester (PET) film liner which had been preheated to about 140° C., to form a bead carrier having a uniform layer of transparent microspheres embedded in the polyethylene layer to a depth corresponding to about 30-40% of their diameter as determined by a magnifying imaging system.

### Comparative Example A (CE-A)

An aqueous polyurethane coating dispersion (Part A) was prepared by mixing 83.78 grams of polyurethane dispersion ALBERDINGK U933, 0.03 grams of pH adjuster AMP-95, 0.19 grams of TRITON GR-7M, 8.47 grams of butyl carbitol, 1.08 grams of TINUVIN-405, and 0.45 grams of TINUVIN-292. The dispersion was diluted with de-ionized water to maintain the coating viscosity (approximately between 70 cps and 180 cps).

The waterborne clear coat solution was prepared by mixing 100 grams of clear coat Part A and 2 grams ofNEOCRYL CX-100 (Part B). The solution mixture was agitated for 5 minutes. The clear coat solution was then coated on the microsphere side of the transfer carrier at about 5 mils (127 micrometer) wet thickness. The clear coat was cured 10 minutes at 90.6° C. in an air oven to achieve a clear coated transfer carrier.

An elastomeric layer was prepared using 504.7 grams of pre-melted FOMREZ 44-111 (having a melting temperature of 60° C.) at 100° C., 5 grams of IRGANOX-1076, 0.3 grams of T-12 catalyst, 88.6 grams of 1,4 butanediol, 401.9 grams of DESMODUR W, 3 grams of TINUVIN-292, and 4.5 grams of TINUVIN-571 by separately feeding the materials into a twinscrew extruder. The extruder setup, conditions, and temperature profiles were similar to that described in Example 1 and in Table 1 in U.S. Pat. No. 8,551,285 (Ho et al.). The isocyanate index was NCO/OH═ 1.03 and hard segment was at 48.25 wt%. The resulting aliphatic thermoplastic polyurethane was extruded as a film of 4 mil (102 micrometer) thickness with a Shore A of 90 and hot laminated at 60° C. to the clearcoat side of the clear coated transfer carrier from above to achieve good interfacial adhesion.

Finally, an acrylic-based pressure sensitive adhesive (PSA) disposed onto a 2 mil (51 micrometer) silicone-coated polyethyleneterephthalate release liner was thermally laminated to the elastomeric layer at 88° C. under 35 psi (0.24 MPa) nip roll pressure. The desired construction was finalized by stripping the PE/PET liner from the rest of the article exposing the microspheres partially embedded in the clearcoat film on the upper surface. The final multilayered article having the following layers in order microspheres/polyurethane clear coat/elastomeric layer/PSA/release liner.

### Example 1 (EX-1)

An elastomeric layer was made and extruded as described in Comparative Example A.

A diol mixture (Part A) was prepared by mixing three different liquid polyester diols (153.15 g CAPA 3031, 163.35 g FOMREZ 55-225, and 169.35 g FOMREZ 55-112) with 2.5 g of flow agent SILWET L-7607, 0.15 g DABCO T-12 catalyst, and a UV light stabilizer package consisting of 7.5 g UVINUL N539 and 4.0 g TINUVIN-292. A polyisocyanate mixture (Part B) was prepared as a mixture of two different polyisocyanates including 250 g of DESMODUR N 3300 and 250 g of DESMODUR XP 2580. The polyurethane layer was prepared from parts A and B by combining in a 1 to 1 ratio by weight and then coated between the elastomeric layer and the microsphere side of the transfer carrier through a notchbar coater with a 2-mil (50.8 micrometer) gap. The multilayered article was then cured at room temperature for 24 hours.

Finally, a PSA and release liner was laminated to the elastomeric side of the construction as described in Comparative Example A and the PE/PET liner was removed exposing the microspheres partially embedded in the clearcoat film on the upper surface, resulting in the final multilayered article having the following layers in order microspheres/polyurethane clear coat/elastomeric layer/PSA/release liner.

TABLE 2

Heat Aged Results

| Sample | ΔE* | ΔL* | Δa* | Δb* |
|---|---|---|---|---|
| CE-A | 1.03 | -0.30 | -0.16 | 0.97 |
| EX-1 | 0.38 | -0.23 | 0.02 | 0.28 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A multilayer article comprising:
(a) a microsphere layer comprising a plurality of microspheres;
(b) a bead bonding layer comprising a first major surface and a second opposing major surface wherein the plurality of microspheres is at least partially embedded in the first major surface of the bead bonding layer, and wherein the bead bonding layer comprises a thermoset polyurethane, and wherein the thermoset polyurethane is derived from one or more liquid polyols; and
(c) an elastomeric layer disposed on the second opposing major surface of the bead bonding layer wherein the multilayer article comprises a pigment.

2. The multilayer article of claim 1, wherein the liquid polyol has a viscosity of at most 6000 cP at 50° C.

3. The multilayer article of claim 1, wherein the pigment comprises at least one of metallic flake or pearlescent particles.

4. The multilayer article of claim 1, wherein at least one of the one or more liquid polyols comprise at least 3 hydroxyl groups and has an equivalent weight of 28 to 3000.

5. The multilayer article of claim 1, wherein at least one of the one or more liquid polyols is selected from a polyester polyol.

6. The multilayer article of claim 1, wherein the elastomeric layer comprises a reaction product of a reaction mixture comprising:
(a) a diisocyanate, optionally, wherein the diisocyanate is chosen from dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluylene diisocyanate, diphenylmethane 4,4′-diisocyanate, 1,4-diisocyanatobutane, 1,8-diisocyanatooctane, or a mixture thereof;
(b) a polymeric diol, optionally, wherein the polymeric diol is selected from at least one of a polyester diol, a polycaprolactone diol, a polyether diol, a polycarbonate diol, or a polyolefin diol; and
(c) a diol chain extender, optionally, wherein the diol chain extender is chosen from ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, or a mixture thereof.

7. The multilayer article of claim 1, wherein the elastomeric layer has thickness of at least 50 micrometers and at most 400 micrometers.

8. The multilayer article of claim 1, wherein the thermoset polyurethane is a reaction product of:
an isocyanate; and
a liquid polyol.

9. The multilayer article of claim 1, wherein the thermoset polyurethane is derived from a solventless polyurethane.

10. The multilayer article of claim 1, wherein the plurality of microspheres are covalently bonded to the bead bonding layer.

11. The multilayer article of claim 1, wherein the refractive index of the plurality of microspheres is less than 1.90.

12. The multilayer article of claim 1, wherein the surface of the plurality of microspheres comprises a nucleophilic group, optionally, wherein the nucleophilic group is an amino group.

13. The multilayer article of claim 1, wherein the plurality of microspheres do not comprise a surface modification.

14. The multilayer article of claim 1, wherein the bead bonding layer is in intimate contact with the elastomeric layer.

15. A method of making a multilayered article, the method comprising:
providing an elastomeric layer;
disposing onto a first major surface of the elastomeric layer a solventless curable polyurethane coating layer and a plurality of microspheres to form a curable multilayered article; and then
curing the curable multilayered article, wherein the multilayered article comprises a pigment.

16. The multilayer article according to claim 1, further comprising an adhesive layer disposed along a major surface of the elastomeric layer, opposite the bead bonding layer.

17. The multilayer article according to claim 16, wherein the adhesive is a (meth)acrylic pressure sensitive adhesive.

18. The multilayer article according to claim 14, further comprising a disposable liner disposed on the adhesive opposite the elastomeric layer.
